(19) United States
(12) Patent Application Publication
(10) Pub. No.: US 2022/0043130 A1
(43) Pub. Date: Feb. 10, 2022

(54) OPTOELECTRONIC SENSOR AND METHOD FOR FRONT WINDOW MONITORING

(71) Applicant: SICK AG, Waldkirch (DE)

(72) Inventor: Fabian JACHMANN, Waldkirch (DE)

(21) Appl. No.: 17/393,749

(22) Filed: Aug. 4, 2021

(30) Foreign Application Priority Data
Aug. 7, 2020 (DE) 102020120908.8

(51) Int. Cl. G01S 7/497; G01S 7/481; G01S 17/42

(52) U.S. Cl. CPC G01S 7/497; G01S 7/4817; G01S 2007/4975; G01S 7/4813; G01S 17/42; G01S 7/4814

(57) ABSTRACT

An optoelectronic sensor for detecting objects in a monitoring area, the sensor comprising a light transmitter for transmitting a scanning beam, a movable deflection unit for periodically scanning the monitoring area with the scanning beam, a light receiver for generating a received signal from the scanning beam remitted by the objects, a front window, and a control and evaluation unit configured to obtain information about the objects in the monitoring area from the received signal and to detect impaired light transmissivity of the front window in a front window monitoring that evaluates a front window reflection that is generated at the front window by the scanning beam, wherein the control and evaluation unit is further configured to increase the sensitivity of the detection for the front window monitoring.

The invention relates to an optoelectronic sensor, in particular a laser scanner, and a method for monitoring a front window of an optoelectronic sensor.

Laser scanners are often used for optical monitoring. In these scanners, a light beam generated by a laser periodically scans a monitored area with the aid of a deflection unit. The light is remitted or reflected by objects in the monitoring area and evaluated in the laser scanner. The angular position of the deflection unit is used to determine the angular position of the object, and the distance of the object from the laser scanner is determined from the light time of flight using the speed of light. Two basic principles are known for measuring the light time of flight. In phase-based methods, the transmitted light is modulated and the phase shift of the received light compared to the transmitted light is evaluated. In pulse-based methods or pulse time of flight methods, that are usually used in safety technology, the transmitter operates in a single pulse mode with relatively high pulse energies, and the laser scanner measures object distances based on the time of flight between transmission and reception of a single light pulse. In a pulse averaging method, as for example known from EP 2 469 296 B1, a large number of individual pulses are transmitted for a measurement, and the received pulses are evaluated statistically.

With the angle and distance information, the location of an object in the monitoring area is detected in two-dimensional polar coordinates. This can be used to determine the positions of objects or their contours. The third spatial coordinate can also be detected by a relative movement in the transverse direction, for example by a further degree of freedom of movement of the deflection unit in that the laser scanner or the object are moved with respect to one another. In this way, three-dimensional contours can also be measured.

The rotating mirror of the laser scanner is sometimes replaced by rotating the entire measuring head including light transmitter and light receiver. A scanner of that kind is disclosed in DE 197 57 849 B4. Likewise, a rotatable transmitter and receiver unit is provided in EP 2 388 619 A1. It is wirelessly supplied with energy, for example using a transformation principle, from the rotationally fixed areas of the sensor, while data transmission is wireless using radio or optical means.

Laser scanners are not only used for general measuring tasks, but also in safety engineering or person protection for monitoring a source of danger, such as a dangerous machine. A safety laser scanner for safety applications is known from DE 43 40 756 A1. It monitors a protective field that must not be entered by the operating personnel during operation of the machine. If the safety laser scanner detects an impermissible intrusion into the protective field, such as a leg of an operator, it triggers an emergency stop of the machine. Other intrusion into the protective field, for example by static machine parts, can be taught in as permissible in advance. Warning fields are often located in front of of the protective fields, where intrusions only cause a warning in order to prevent the protective field intrusion and the safeguarding in advance and thus to increase the availability of the system. Safety laser scanners usually work pulse-based.

These safety laser scanners have to work particularly reliably and therefore fulfill very demanding safety requirements, for example the EN13849 standard for machine safety or the EN61496 device standard for electro-sensitive protective equipment (ESPE). In order to be compatible with these safety standards, a number of measures must be taken, such as safe electronic evaluation by redundant, diversified electronics, function monitoring or monitoring of contamination of optical components. This applies in particular to the detection of any impairment of the transmissivity of a front window of the laser scanner, which must be responded to with a safety-oriented shutdown if the detection capability is restricted.

In order to detect such interfering influences, a laser scanner usually uses optical test channels that check different positions of the front window area by means of transmission. In a conventional solution for example known from DE 43 45 446 C2, a large number of independent optical test channels are distributed over the entire angular range of the front window, radiating through different areas of the front window as a test and thus detecting impaired transmission. For this purpose, a concave-shaped front window is often used, which is difficult to clean. The distribution of the test channels has to be dense enough to reliably detect the small contamination or manipulation objects everywhere as required by the standard, despite testing only pointwise. A large number of test channels of course increases the manufacturing costs and the required installation space. In addition, the test channels are located quite close to the outer contour of the laser scanner in order to avoid the rotating deflection unit. This renders them susceptible to interference from extraneous light, or from other sensors or reflectors that are located nearby by chance or for manipulation.

Contamination on the front window, depending on its properties, may weaken the measurement signal, but may also generate interference pulses that are superimposed on the actual measurement signal. The laser scanner thus may detect the front window as an object and measures its distance. This could still be filtered out with relative ease on the basis of the known distance of the front window. However, there remains an unsolved problem that the interference pulse from the front window occludes possible measurement pulses from close targets just in front of the laser scanner. Therefore, it is conventionally aimed at minimizing any optical crosstalk between the transmission and reception channels caused by effects of the front window.

In addition to interfering pulses that only emerge after contamination of the front window, there is a directed front window reflection of the transmitted light beam. This is regularly deflected away from the light receiver by the shape and orientation of the front window and for example guided into a light trap. There are also approaches to use this directed front window reflection for front window monitoring, but they have not yet led to a satisfactory solution that can actually replace the additional test channels.

EP 2 237 065 A1 discloses a laser scanner wherein the entire measuring unit including light source and detector rotates. A test light source and a test detector are also accommodated on the corresponding rotor, while a reflector element is arranged outside the housing. Thus, the test light source and test detector scan the front window in the course of the rotation with the aid of the reflector element. Since the test light detector is necessarily directed outward, it is quite prone to interference by external light.

In DE 10 2015 105 264 A1, test channels are guided through the front window via a reflector that moves along with the rotating mirror. At the end of its specification, DE 10 2015 105 264 A1 discusses various concepts for testing the transmissivity. One possibility is to split off part of the actual scanning beam. However, this approach is considered disadvantageous, since crosstalk into the actual measurement channel is to be feared.

In a laser scanner according to DE 20 2013 102 440 U1, the contamination measurement is based on test channels that measure in a reflective rather than a transmissive arrangement. However, this does not reduce the effort in each individual test channel, nor does it reduce the number of test channels required.

EP 2 482 094 B1 describes a laser scanner that evaluates a reflection on the inside of the front window. However, this is done in a rear dead zone where a section of the front window is specifically metallized for a test of the functionality of the measurement system. The transmissivity of the front window could not possibly be evaluated because of the metallization, and furthermore it is the light transmission in the field of view and not in the dead zone that would have to be tested.

EP 2 642 314 A1 generates test light paths using test light transmitters arranged around the outside of the front window, whose test light is received in the light receiver of the main measuring system after multiple deflections at the front window and further reflectors. Although this saves test light receivers, it is still the basic principle of the test channels distributed around the front window.

It is known from EP 2 927 711 A1 to use a test light transmitter to check the functionality of the measuring system. In one embodiment, its test light path includes a reflection on the front window. It is mentioned that this could be used in a dual function for monitoring the front window for contamination. However, since the test light transmitter is only provided at one point at a single scan angle, the front window would not be meaningfully testable in this way. In any case, an additional test light transmitter would be required per each section of the front window to be tested, so that the hardware overhead for the test channels would still be considerable.

U.S. application Ser. No. 17/169,019 arranges a light deflection element in the beam path of the directed front window reflection beam in order to guide it back to the front window a second time at a different location, and then into the light receiver. This is primarily used in a border area in the transition between the scan angles from the measurement zone to a rear dead zone. The problem of an overlap between the front window reflection beam and the received light beam from close targets remains, and additional test channels are still provided.

It is therefore an object of the invention to ensure the detection capability of an optoelectronic sensor in an improved manner.

This object is satisfied by an optoelectronic sensor for detecting objects in a monitoring area, in particular a laser scanner, the sensor comprising a light transmitter for transmitting a scanning beam, a movable deflection unit for periodically scanning the monitoring area with the scanning beam, a light receiver for generating a received signal from the scanning beam remitted by the objects, a front window, and a control and evaluation unit configured to obtain information about the objects in the monitoring area from the received signal and to detect impaired light transmissivity of the front window in a front window monitoring that evaluates a front window reflection that is generated at the front window by the scanning beam, wherein the control and evaluation unit is further configured to increase the sensitivity of the detection for the front window monitoring.

The object is also satisfied by a method for front window monitoring of a front window of an optoelectronic sensor, wherein a scanning beam is transmitted for detecting objects in a monitoring area, the monitoring area is periodically scanned with the scanning beam, a received signal is generated from the scanning beam remitted by the objects in the monitoring area and this received signal is evaluated in order to obtain information about the objects, and an impaired light transmissivity of the front window is detected in the front window monitoring by evaluating a front window reflection that is generated at the front window by the scanning beam, and wherein the sensitivity of the detection for the front window monitoring is increased.

A light transmitter transmits a scanning beam which periodically scans the monitoring area with the aid of a movable deflection unit, and a light receiver generates a received signal from the scanning beam returning after remission or reflection at an object. These components are the core of a main measuring system of the laser scanner. A rotating mirror is preferably provided as the deflection unit, or the main measuring system as a whole is housed in a rotating measuring head. Throughout this specification, the terms preferably or preferred refer to advantageous, but completely optional features. A control and evaluation unit evaluates the received signal from the light receiver to obtain information about the scanned objects, in particular to measure their distances using a time-of-flight method.

The control and evaluation unit also detects, in a front window monitoring, when the light transmission capability or transmissivity of a front window of the sensor is impaired. For this purpose, a front window reflection that the front window generates from the scanning beam is evaluated. The front window monitoring for its sufficient light transmissivity thus is based on the light transmitter of the main measuring system. The front window reflection can be generated in two ways, firstly by directed reflection at the front window, and secondly by scattering at contamination on the front window.

The invention starts from the basic idea of increasing the sensitivity of the detection for the front window monitoring. The sensitivity is thus adapted to the needs of the front window monitoring. As a result, even weaker interference pulses caused by contamination of the front window are still reliably detected. The requirements of object detection and front window monitoring are often contradictory. Accordingly, the sensitivity is preferably reduced again in phases without front window monitoring and thus adapted to the needs of the actual measurement of objects in the monitoring area.

The invention has the advantage that the conventionally incompatible conditions of detection capability, in particular at close range, and reliable front window monitoring are yet fulfilled at the same time. Conventionally, front window monitoring based on front window reflections has not been used because, among other reasons, dark dust could not be detected with sufficient reliability to date, but it can certainly cause a loss of detection. This problem is solved by increasing the sensitivity of the detection during front window monitoring. Thus, a front window monitoring based on the main measuring system and at the same time conforming to applicable standards becomes possible. The costs for a front window monitoring are thus considerably reduced. Depending on the embodiment, no or at least fewer test channels are required. Manufacturing costs, complexity and size are reduced.

The control and evaluation unit preferably is configured to perform the front window monitoring cyclically with increasing the sensitivity of the detection. Thus, there is a regular check of the transmissivity of the front window with increased sensitivity. In the measurement phases in between, the sensitivity of the detection is adapted to the needs of the object detection.

The control and evaluation unit preferably is configured to perform the front window monitoring over a periodic scan. In a laser scanner, a periodic scan is also referred to as a scan. The front window monitoring system therefore checks the entire relevant area of the front window over one or more scans.

The control and evaluation unit preferably is configured to repeat the front window monitoring at time intervals of one second, several seconds, five seconds, ten seconds or several tens of seconds. These time intervals are preferably of equal length, so the front window monitoring is cyclical. The duration of the time interval depends on how fast detection of contamination of the front window is required. The usual scanning period of a laser scanner is well below one second, so that a front window monitoring is only performed after a large number of measurement cycles.

The control and evaluation unit preferably is configured not to generate information about the objects in the monitoring area during a front window monitoring, or to discard such information or to flag it as unreliable. During a front window monitoring, the sensor is not optimally adjusted for a measurement. Therefore, during this time, preferably no evaluations take place, in particular no time-of-flight measurements for objects in the monitoring area, and the unused computing capacities are available for an evaluation of the front window monitoring. However, the front window monitoring should preferably still take elements of the time-of-flight measurement into account, or at least corresponding time windows, so that, for example, only very close echoes corresponding to the distance of the front window are interpreted as contamination and not, incorrectly, a distant bright object. It is also conceivable yet to go through the entire evaluation, but to discard the results afterwards or, for example, to flag them as having been measured during front window monitoring.

The control and evaluation unit preferably is configured to increase the sensitivity of detection by increasing the transmission power of the light transmitter, increasing the sensitivity of the light receiver and/or lowering a detection threshold for detecting objects. These ways of adjusting the sensitivity of detection can be applied individually or in combination. Adjusting the optical output power of the light transmitter is a transmitter-side adjustment. Limits of eye protection or the laser protection class should be considered. The sensitivity of the light receiver itself is changed, for example, by the voltage applied to an APD (avalanche photodiode) or SPAD (single photon avalanche diode). In addition, a gain factor of an amplifier, which is connected downstream of the light receiver, can be adjusted. Another possibility for adjustment in the receiving path is to lower a detection threshold, which is used, for example, to determine a reception timing of a received pulse. This can be an actual threshold operation using one or more thresholds to locate a received pulse, either with an analog threshold detector or in a digitized received signal, but also threshold criteria used to evaluate a digitized received signal.

The control and evaluation unit preferably is configured to increase the sensitivity of the detection for the front window monitoring by a factor of two to ten or more. The sensitivity is thus increased very significantly. During front window monitoring, saturation or inaccurate time-of-flight measurements caused by excessively wide received pulses are largely unproblematic. The only issue here is reliable detection of contamination, and for that goal, the advantages of very sensitive detection outweigh the disadvantages.

The control and evaluation unit preferably is configured to lower the sensitivity of the detection in phases without front window monitoring to such an extent that the front window reflection remains too weak for front window monitoring. During measurement phases without front window monitoring, the system is adjusted so that the front window reflection remains small, thus not interfering with the measurement, and could not be used for reliable front window monitoring. For example, measures are taken to reduce the directed front window reflection, such as using deflection by a slanted front window, front window coatings or light traps.

The sensor preferably is configured as a safety sensor in accordance with the EN 62998 standard. Conventional safety laser scanners are configured for permanent simultaneous object detection and front window monitoring. Depending on the requirement rate of the safety function, EN 62998 allows the reliability of the sensor to be limited. For example, if only a few violations of the monitored area or the safety-relevant subareas therein are to be expected per day, then it is acceptable for the sensor not to guarantee its safety function for a few seconds per day, or only to a limited extent. Cyclic front window monitoring, during which the actual measuring system is only available to a limited extent or not at all, is therefore permitted in a sensor that is certified in accordance with EN 62998. According to the invention, safety-relevant contamination is detected fast enough, for example in five seconds at the latest by correspondingly frequent front window monitoring, and in this case the device is brought into a safe state.

The sensor preferably comprises a safety output for a safety-related shutdown signal. The safety output, in particular an OSSD (Output Signal Switching Device), is safe in the sense of relevant standards, for example of two-channel design, and is used to initiate a safety-related measure such as an emergency stop or, more generally, to establish a safe state. The control and evaluation unit preferably is configured for a protective field evaluation wherein it is determined whether an object is located in at least one configured protective field within the monitoring area. This means that a proven form of safety evaluation is already integrated in the sensor, which directly provides a safety-related shutdown signal for a machine or an intermediate safety controller.

The sensor preferably is configured as a multilayer scanner with a plurality of scanning beams separated in elevation, wherein at least one of the scanning beams is used for front window monitoring. A multilayer scanner uses not just one, but a plurality of scanning beams, and accordingly monitors a plurality of monitoring planes. With sufficient number or density of scanning beams, the front window monitoring can be based on one or some of these scanning beams. If the monitoring gap in elevation is acceptable, one scanning beam can be dedicated to be used only for the front window monitoring. For this scanning beam, the sensitivity can be permanently increased.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The only FIGURE of the drawing shows in:

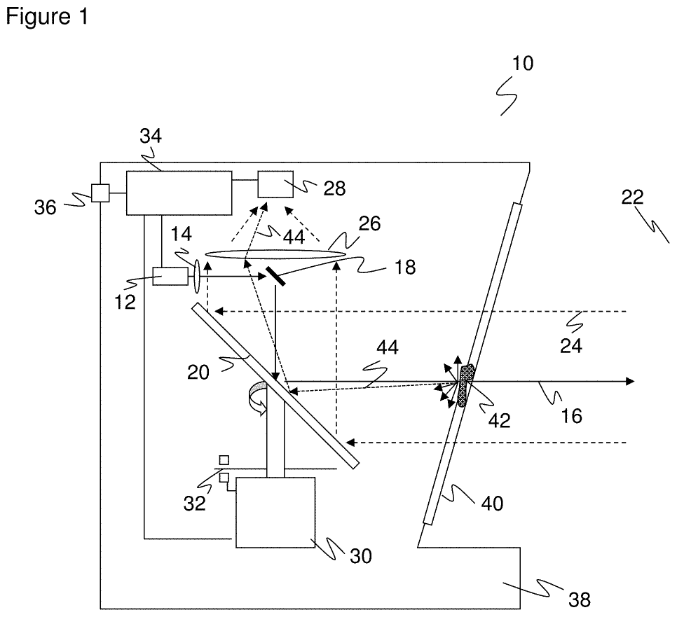

FIG. 1 a sectional view of an optoelectronic sensor in an embodiment as a laser scanner.

FIG. 1 shows a schematic sectional view of an optoelectronic sensor 10 in an embodiment as a laser scanner. A light transmitter 12, such as a laser in the form of an edge emitter or a VCSEL, transmits a light signal that is periodically amplitude modulated or preferably has at least one short light pulse. The transmitted light is collimated by a transmitting optics 14 to form a transmitted light beam 16, which is directed, via a deflection mirror 18 and a movable deflection unit 20, into a monitoring area 22, where it is remitted or reflected by any object present. A portion of this light returns to the sensor 10 as an incident remitted light beam 24 and is deflected by the deflection unit 20 to a receiving optics 26 and from there is focused onto a light receiver 28, for example at least one photodiode, APD (avalanche photo diode) or SPAD (single photon avalanche diode). The sensor 10 according to FIG. 1 has a coaxial arrangement wherein the transmitted light beam 16 and the incident remitted light beam 24 propagate along one optical axis. This is to be understood as an example, a biaxial arrangement is also conceivable, just as the coupling on the transmitting side onto the common optical axis can also be realized by other means than via the deflection mirror 18.

The deflection unit 20 can be configured as an oscillating mirror, but is usually a rotating mirror that rotates continuously by driving a motor 30. Alternatively, no rotating mirror is provided, but the deflection unit 20 is configured as a rotating measuring head including light transmitter 12 and light receiver 28. The respective angular position of the deflection unit 20 is detected by an encoder 32. The light beam 16 or scanning beam transmitted by the light transmitter 12 thus sweeps over the monitoring area 22 generated by the movement. If a remitted light beam 24 from the monitoring area 22 is received by the light receiver 28, the angular position of the deflection unit 20 measured by the encoder 32 can be used to infer the angular position of the object in the monitoring area 22.

In addition, the light time of flight from the transmission of the light beam 16 to the reception of the remitted light beam 24 after reflection at the object in the monitoring area 22 is determined. Any light time of flight method is conceivable for this purpose, in particular phase methods, pulse methods or pulse average methods, with pulse-based methods preferably being used in safety applications. From the light time of flight, the distance of the object from the sensor 10 is inferred using the speed of light. This evaluation takes place in an evaluation unit 34, which is connected to the light transmitter 12, the light receiver 28, the motor 30, and the encoder 32.

Two-dimensional polar coordinates of all objects in the monitoring area 22 are then available via the angle and the distance. In the monitoring area 22, two-dimensional protective fields can thus be defined, for example, where impermissible objects such as operators or their body parts are not allowed to intrude. If the evaluation unit 34 detects an impermissible protective field intrusion, a safety-related shutdown signal is output via a safe output 36 (OSSD, Output Signal Switching Device), for example to stop a monitored dangerous machine or to move it into a non-dangerous position. This is only one possible application of the sensor 10. Alternatively, measurement data is output via the output 36, for example.

All the above-mentioned functional components are arranged in a housing 38, which comprises a front window 40 in the area of the light exit and light entry. In a laser scanner, the front window 40 is often, but not necessarily, configured as a body of rotation and does not necessarily have to extend over 360°, so that a certain angular range may remain as a dead zone. Deviating from FIG. 1, a curvature is also conceivable instead of a straight contour in cross-section.

In order to guarantee the detection capability of the sensor 10, the front window 40 is monitored for light transmissivity. If the light transmissivity is impaired to such an extent that an object might be missed, a safety-related reaction is triggered in a safety-related application of the sensor 10. Conventionally, a plurality of test channels distributed over the circumference are provided for front window monitoring. This is also conceivable according to the invention in a supplementary manner. However, the front window monitoring according to the invention to be explained is not based on test channels, but on an evaluation of front window reflections.

A front window reflection can have at least two causes. Firstly, when the transmitted light beam 16 exits, a certain amount is reflected at the front window 40. This directed front window reflection is usually regarded as an interference signal. This is why the front window 40 in FIG. 1 is inclined, and the directed front window reflection thus does not impinge on the light receiver 28. In other embodiments, however, the directed front window reflection can be guided into the light receiver 28 and used for front window monitoring directly, for example via a vertically arranged front window, or indirectly, for example via one or more light deflectors.

Secondly, a portion of the transmitted light beam 16 is scattered by the front window 40 in the presence of contamination 42. The non-directed scattering provides a front window reflection 44, which impinges on the light receiver 28 via the receiving path including the movable deflection unit 20 and the receiving optics 26. However, the signal from the front window reflection 44 is relatively weak. This is particularly true in the case of dark dust as contamination 42. Therefore, under normal conditions where the sensitivity of the sensor 10 is set to detect objects in the monitoring area 22, the front window 40 cannot be reliably monitored using the front window reflection 44.

However, front window monitoring is possible by increasing the sensitivity, when the signal components of the front window reflection 44 from a contamination 42 become strong enough. The sensitivity can be adjusted in various ways on the transmitter or receiver side, and combinations are also possible: Changing the transmitting power of the light transmitter 12, changing the sensitivity of the light receiver 28, in particular in each case by changing the applied voltage, adjusting an amplification factor of an amplifier in the receiving path downstream of the light receiver 28 (VGA, variable gain amplifier) or changing an analog threshold for signal sampling or a threshold in a digital signal evaluation in the control and evaluation unit 34.

With increased sensitivity, signal components of the front window reflection 44 may superimpose measurement signals from near objects, so that such objects might be missed. However, the IEC61496-3 standard, which has so far been the only standard for safety laser scanners considered relevant, requires that the main measuring system is permanently available for the detection of persons with 100% reliability. This cannot be guaranteed when using increased sensitivity.

The EN 62998 safety standard is designed for application-specific sensor solutions. It can be used if there is no explicitly applicable B standard, for example because it does not cover the application location or the technology used for the solution. For certain applications, for example outdoors, EN 62998 can be used instead of IEC 61496-3.

EN 62998 in turn allows the reliability of the sensor 10 to be limited depending on the requirement rate of the safety function. If, for example, only a few violations of the monitoring area 22 or the protective fields configured therein or other safety-relevant events are to be expected per day, then it is acceptable for a few seconds per day that the sensor 10 cannot perform its safety function or can only perform it in a restricted manner.

According to the invention, this is used to temporarily increase the sensitivity of the detection for front window monitoring. This can be done cyclically, for example by using a high-sensitivity measurement for front window monitoring after every five seconds. The sensitivity is preferably increased significantly, for example by a factor of two to ten or more, since the aim here is to detect even minor effects of dark dust or similar contamination 42. The high sensitivity is maintained for the front window monitoring, for example for one or more scans or revolutions of the deflection unit 20, and then reset for further measurements of objects in the monitoring area. Thus, after one cycle of front window monitoring at the latest, contamination of the front window 40 is detected and, to this extent, the requirement of IEC 61496-e is also met.

During the increased sensitivity, even small interfering signals or interfering pulses originating from a contamination 42 are reliably detected. On the other hand, other measurement signals, in particular from near objects close to the front window 40, may not be detected during this time. Moreover, during this time, the sensor 10 reacts very sensitively to interfering objects in the monitoring area 22, such as dust particles. Therefore, during front window monitoring, preferably no measurement results are obtained about objects in the monitoring area 22, or they are discarded or marked as unreliable.

So far, a sensor 10 having one transmitted light beam 16 and thus, in the case of a laser scanner, only one monitoring layer has been explained. The front window monitoring according to the invention can also be used with a multilayer scanner. This is a laser scanner having a plurality of scanning beams in elevation one above the other and thus monitoring a three-dimensional spatial area using a plurality of planes, or more precisely using a structure similar to nested hourglasses. The plurality of scanning beams are generated by a plurality of light transmitters or beam splitters and are accordingly received in a plurality of light receivers or one light receiver having a plurality of receiving zones or pixels.

Since a multilayer scanner detects an object in its multiple layers, it is statistically less likely that there will be a loss of detection due to local or homogeneous contamination. Thus, insofar as additional test channels were still required for front window monitoring in a single-layer laser scanner, fewer test channels are sufficient in a multilayer scanner, or any remaining test channels in a single-layer laser scanner may no longer be necessary in a multilayer scanner. Furthermore, it is sufficient to test the front window 40 with only part of the plurality of scanning beams. An advantageous embodiment is a dedicated scanning beam that continuously tests the front window 40 at high sensitivity. Any measurement gaps are compensated for by the neighboring scanning beams, or the small measurement gap in elevation due to this dedicated scanning beam for front window monitoring is tolerated.

1. An optoelectronic sensor for detecting objects in a monitoring area, the sensor comprising a light transmitter for transmitting a scanning beam, a movable deflection unit for periodically scanning the monitoring area with the scanning beam, a light receiver for generating a received signal from the scanning beam remitted by the objects, a front window, and a control and evaluation unit configured to obtain information about the objects in the monitoring area from the received signal and to detect impaired light transmissivity of the front window in a front window monitoring that evaluates a front window reflection that is generated at the front window by the scanning beam, wherein the control and evaluation unit is further configured to increase the sensitivity of the detection for the front window monitoring.

2. The sensor according to claim 1,
the sensor being configured as a laser scanner.

3. The sensor according to claim 1,
wherein the control and evaluation unit is configured to perform the front window monitoring cyclically with increasing the sensitivity of the detection.

4. The sensor according to claim 1,
wherein the control and evaluation unit is configured to perform the front window monitoring over a periodic scan.

5. The sensor according to claim 1,
wherein the control and evaluation unit is configured to repeat the front window monitoring at time intervals of at least one of one second, a few seconds, five seconds, ten seconds, or a few tens of seconds.

6. The sensor according to claim 1,
wherein the control and evaluation unit is configured not to generate information about the objects in the monitoring area during a front window monitoring, or to discard such information or to flag it as unreliable.

7. The sensor according to claim 1,
wherein the control and evaluation unit is configured to increase the sensitivity of detection by at least one of increasing the transmission power of the light transmitter, increasing the sensitivity of the light receiver and lowering a detection threshold for detecting objects.

8. The sensor according to claim 1,
wherein the control and evaluation unit is configured to increase the sensitivity of the detection for the front window monitoring by a factor of two to ten.

9. The sensor according to claim 1,
wherein the control and evaluation unit is configured to lower the sensitivity of the detection in phases without front window monitoring to such an extent that the front window reflection remains too weak for front window monitoring.

10. The sensor according to claim 1,
the sensor being configured as a safety sensor in accordance with the EN 62998 standard.

11. The sensor according to claim 1,
the sensor being configured as a multilayer scanner with a plurality of scanning beams separated in elevation, wherein at least one of the scanning beams is used for front window monitoring.

12. A method for front window monitoring of a front window of an optoelectronic sensor, wherein a scanning beam is transmitted for detecting objects in a monitoring area, the monitoring area is periodically scanned with the scanning beam, a received signal is generated from the scanning beam remitted by the objects in the monitoring area and this received signal is evaluated in order to obtain information about the objects, and an impaired light transmissivity of the front window is detected in the front window monitoring by evaluating a front window reflection that is generated at the front window by the scanning beam, and wherein the sensitivity of the detection for the front window monitoring is increased.
